(19) United States
(12) Patent Application Publication
(10) Pub. No.: US 2006/0106634 A1
(43) Pub. Date: May 18, 2006

(54) System and method of vehicle upfit

(75) Inventors: Blackford F. Brauer, Charlotte, NC (US); Charles J. Peters, St. Louis, MO (US)

Correspondence Address: HARNESS, DICKEY & PIERCE, P.L.C., P.O. BOX 828, BLOOMFIELD HILLS, MI, 48303, US

(73) Assignee: Knaack Manufacturing Co., Crystal Lake, IL (US)

(21) Appl. No.: 11/260,732

(22) Filed: Oct. 27, 2005

Related U.S. Application Data
(60) Provisional application No. 60/624,148, filed on Oct. 29, 2004.

(51) Int. Cl. G06Q 99/00

(52) U.S. Cl. 705/1

(57) ABSTRACT

A vehicle upfit configurator tool is made available to customers purchasing one or more of a vehicle upfit and an upfitted vehicle. Also, human assistance relating to use of the configurator tool is made available to the customers. Further, one or more of vehicles, vehicle upfitting components, and vehicle upfitting services are provided.

### CROSS-REFERENCE TO RELATED APPLICATIONS

This application claims the benefit of U.S. Provisional Application No. 60/624,148, filed on Oct. 29, 2004. The disclosure of the above application is incorporated herein by reference in its entirety for any purpose.

### FIELD OF THE INVENTION

The present invention generally relates to vehicle upfit, and relates in particular to implementation, operation, and use of a vehicle upfit configurator tool.

### BACKGROUND OF THE INVENTION

Vehicle customization or upfitting often occurs with commercial vehicles such as trucks or vans that are used by contractors, plumbers, HVAC technicians, and the like. An individual or company may purchase one or more vehicles and visit a regional/local upfitter to have upfitting components installed on a custom basis. An individual or company may alternatively purchase one or more pre-upfitted vehicles from a dealer. An individual, company, or vehicle manufacturer may also contract with an upfitting supplies manufacturer to provide upfitting supplies and/or services contingent upon purchase of one or more vehicles by a customer. As circumstances dictate, the upfitting supplies manufacturer can use captive and/or non-captive local upfitters to provide the installation services.

Typical vehicle upfit processes encounter difficulty in configuring a vehicle upfit on a per customer basis without undue delay. Various business arrangements have evolved that address this difficulty in various ways. For example, a regional/local purchase pattern illustrated in FIG. 1 accomplishes upfit of a customer's vehicle following the purchase from a local vehicle dealer. A vehicle supplying process 20, including sub-processes 20A-20C, transacts with an upfitted vehicle purchasing process 30, including sub-processes 30A-30D, by conveying a non-upfitted vehicle to a customer in the normal fashion. Meanwhile, a local vehicle upfitting process 40, including sub-processes 40A-40E, transacts with an upfitting component supplying process 50, including sub-processes 50A-50C, by conveying upfitting supplies from a manufacturer to an upfitting service provider.

Next, the upfitted vehicle purchasing process 30 transacts with the local vehicle upfitting process 40 by conveying a record of a vehicle upfit generated by vehicle upfit configuration sub-process 30B. Sub-process 30B typically involves a consultation between the local vehicle upfitter and the customer, but the customer directs the upfit configuration, while the upfitter offers available upfit options. The upfitter can then quote a price for upfit materials and services at sub-process 40D, but does so at the risk that the record of the vehicle upfit can be incorrect, or can be misinterpreted by personnel installing the upfitting components. As a result, upfitters often request a draft rendering of the upfitted vehicle from the upfitting supplies manufacturer, which in turn hires an outside draftsperson to render the upfitted vehicle at sub-process 50C.

Days or weeks later, the rendering is provided to the customer for final approval with the quote from sub-process 40D. The customer may then purchase the upfit at sub-process 40E, or request changes in the draft rendering. In the latter case, the rendering process can occur again, which can delay purchase of the upfitting process by weeks or months.

In another example, a Top-100 fleet purchase pattern illustrated in FIG. 2 accomplishes upfit of a customer's fleet of vehicles following lease of the fleet from a leasing company. Accordingly, a fleet managing process 60, including sub-processes 60A-60B, transacts with a leasing process 70, including sub-processes 70A-70D, by conveying an order for a fleet of upfitted vehicles. The fleet managing process 60 subsequently transacts with a local upfitting process 80, including subprocess 80A, by receiving a fleet of upfitted vehicles. Meanwhile, a vehicle supplying process 90, including sub-processes 90A-90B, transacts with the leasing process 70 and the local upfitting process 80 by receiving notification of the fleet order and delivering the non-upfitted fleet to the local upfitter.

Concurrently, the leasing process 70 interacts with an upfitting component supplying process 100, including sub-processes 100A-10B, by conveying a record of a vehicle upfit to the upfitting component supplying process 100, which in turns conveys a quote for materials and services together with a rendering of the upfitted vehicle. In this purchasing pattern, delay is again experienced by the need to manually render the upfitted vehicle, perhaps numerous times. A variation on the Top-100 fleet purchase pattern is illustrated in FIG. 3, in which the leasing process 70 transacts with the vehicle supplying process 90 by locating the vehicle at sub-process 70E and conveying the vehicle order to the vehicle dealer, which in turn orders and stocks the vehicle at sub-processes 90C-90D.

In a further example, a “free” Original Equipment Manufacturer (OEM) market purchase pattern illustrated in FIG. 4 accomplishes upfit of a customer's vehicles following purchase of a minimum number of the vehicles from the local vehicle dealer; the dealer includes the upfits on a complementary basis with the order of the minimum number of vehicles. Accordingly, an upfitting supplies providing process 110, including sub-processes 110A-110C, transacts with a complementary upfit providing process 120, including sub-processes 120A-120C, by conveying records of preconfigured upfits and quotes to the complementary upfit providing process 120. The complementary upfit providing process 120 next transacts with a vehicle supplying process 130, including sub-processes 130A-130D, by conveying a record of complementary upfit availability with terms and conditions to the vehicle supplying process 130.

The vehicle supplying process 130, transacts with an upfitted vehicle purchasing process 140, including sub-processes 140A-140C, by conveying the availability of the complementary upfit to the customer during the vehicle sale/purchase. Next, the upfitted vehicle purchasing process 140 transacts with the vehicle supplying process 130 by conveying an application for an upfit, and the vehicle supplying process 130 responds by transacting with the complementary upfit providing process 120 in the form of submitting the application.

The complementary upfit providing process transacts with the upfitting supplies providing process 110 by conveying an acceptance of an offer to purchase predefined upfits on behalf of the customer. The upfitting supplies providing process 110 then transacts with a local upfitting process 150, including sub-process 150A, by conveying the record of vehicle upfit and instructions to upfit the vehicles purchased by the customer. Finally, the vehicle supplying process 130 transacts with the local upfitting process 150 by conveying the vehicles purchased by the customer, and the local vehicle upfitting process transacts with the upfitted vehicle purchasing process by conveying the upfitted vehicles. It can therefore, be appreciated that the problem of configuring the upfit avoids the delay of months by preconfiguring and prerendering the available upfits, and limits the choices of the user. Accordingly, if the user wishes to alter the upfit in any way, then the details of the alterations will have to be worked out with the local upfitter in accordance with the process illustrated in FIG. 1.

### SUMMARY OF THE INVENTION

In accordance with the present invention, a vehicle upfit configurator tool is made available to customers purchasing one or more of a vehicle upfit and an upfitted vehicle. Also, human assistance relating to use of the configurator tool is made available to the customers. Further, one or more of vehicles, vehicle upfitting components, and vehicle upfitting services are provided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a swim lane diagram illustrating a typical regional/local purchase pattern of a vehicle upfitting process according to the prior art;

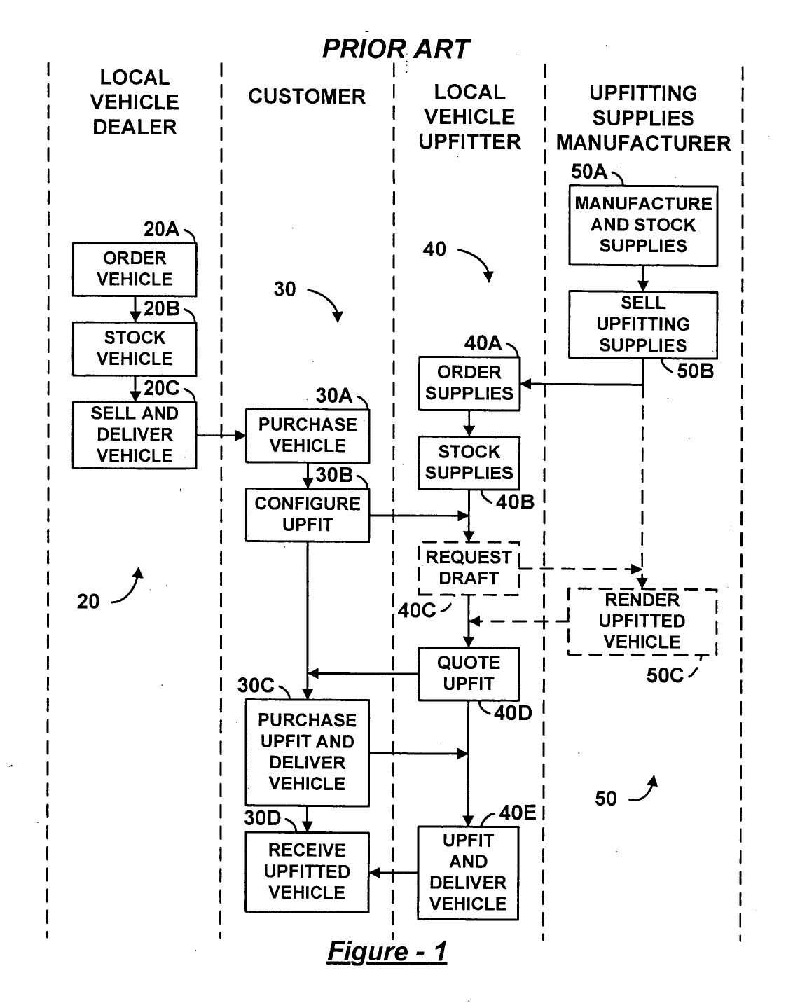

FIG. 2 is a swim lane diagram illustrating a first example of a typical Top-100 fleet purchase pattern of a vehicle upfitting process according to the prior art;

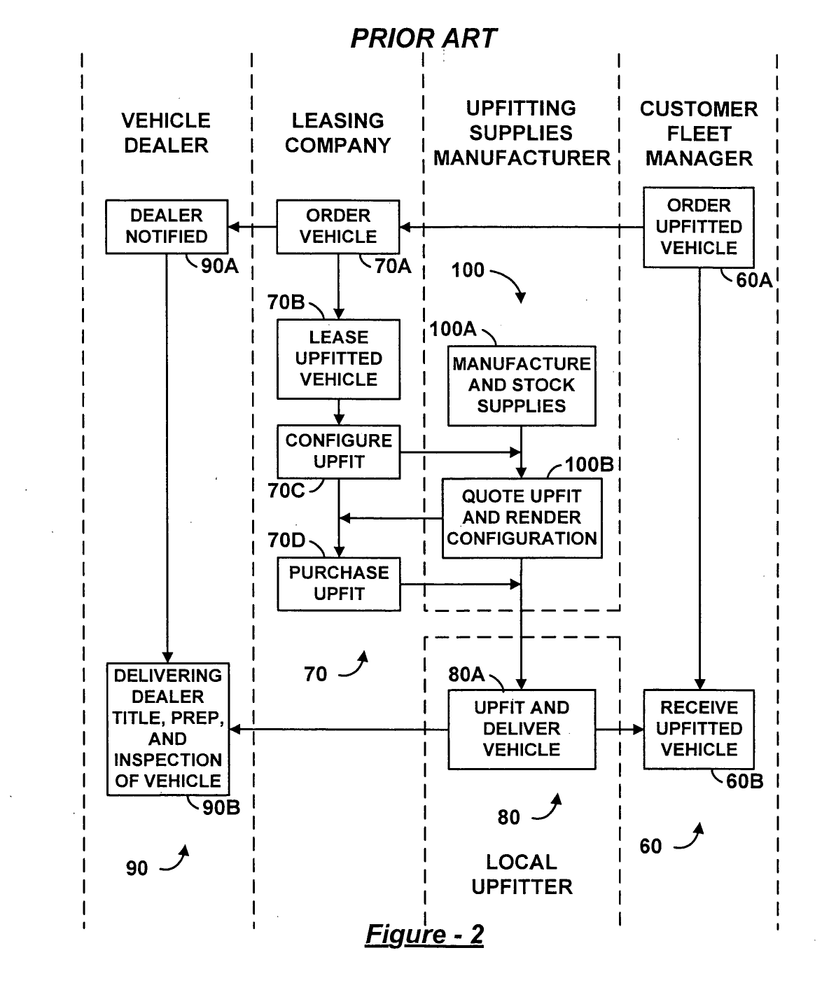

FIG. 3 is a swim lane diagram illustrating a second example of a typical Top-100 fleet purchase pattern of a vehicle upfitting process according to the prior art;

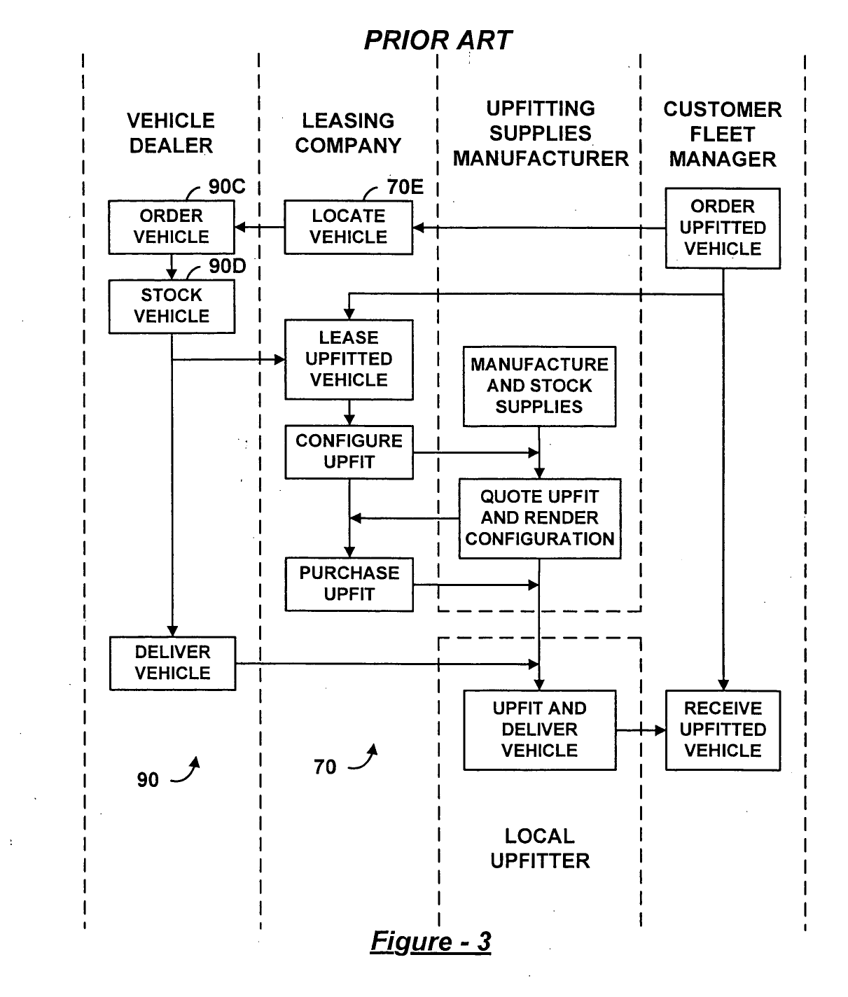

FIG. 4 is a swim lane diagram illustrating a typical “free” OEM market purchase pattern of a vehicle upfitting process according to the prior art;

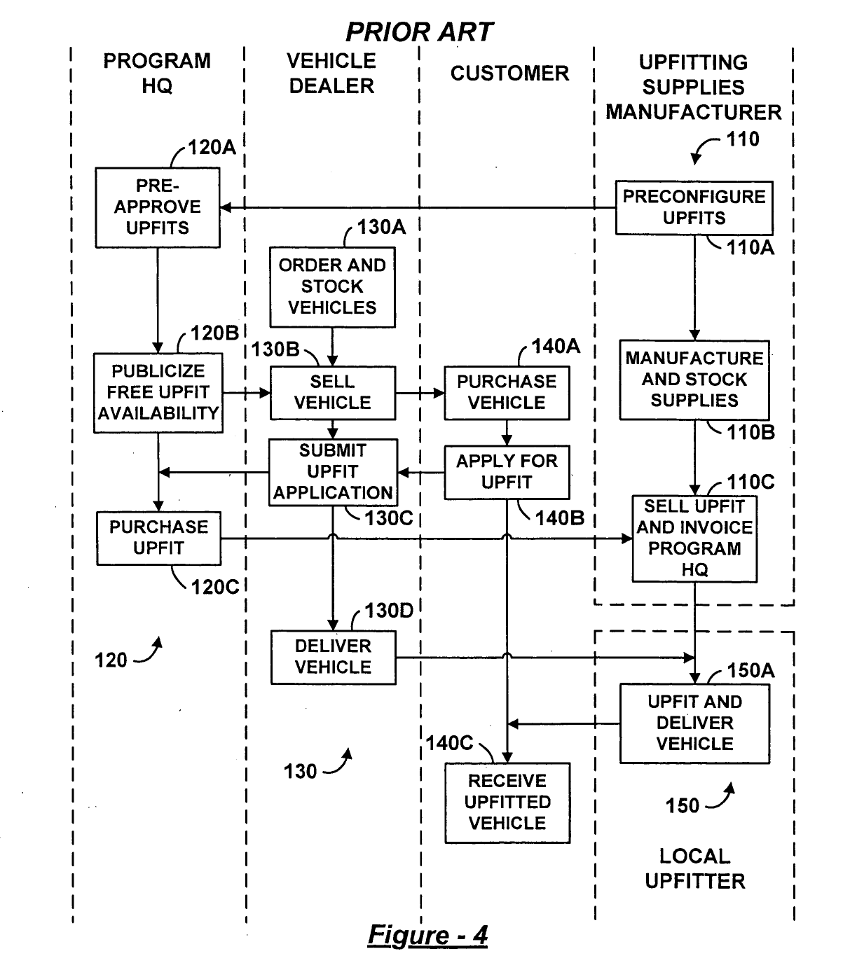

FIG. 5 is a flow diagram illustrating a method of manufacturing an upfitted vehicle according to the present invention;

FIG. 6 is a flow diagram illustrating a method of manufacturing a record of a vehicle upfit in accordance with the present invention;

FIG. 7 is an entity relationship diagram illustrating an online embodiment of a vehicle upfit configuration system tool according to the present invention;

FIG. 8 is an entity relationship diagram illustrating a desktop embodiment of a vehicle upfit configuration system in accordance with the present invention;

FIG. 9 is a frontal view of a user interface of a vehicle upfit configuration system in accordance with the present invention;

FIG. 10 is a block diagram illustrating a vehicle upfit configuration system in accordance with the present invention;

FIG. 11 is a flow diagram illustrating a method of operation for a vehicle upfit configuration system in accordance with the present invention;

FIG. 12 is a flow diagram illustrating additional embodiments of a method of operation for a vehicle upfit configuration system in accordance with the present invention;

FIG. 13 is a flow diagram illustrating further embodiments of a method of operation for a vehicle upfit configuration system in accordance with the present invention;

FIG. 14 is a swim lane diagram illustrating a first example of a novel regional/local purchase pattern of a vehicle upfitting process in accordance with the present invention;

FIG. 15 is a swim lane diagram illustrating a second example of a novel regional/local purchase pattern of a vehicle upfitting process in accordance with the present invention;

FIG. 16 is a swim lane diagram illustrating a third example of a novel regional/local purchase pattern of a vehicle upfitting process in accordance with the present invention.

FIG. 17 is a swim lane diagram illustrating a first example of a novel Top-100 fleet purchase pattern of a vehicle upfitting process in accordance with the present invention;

FIG. 18 is a swim lane diagram illustrating a second example of a novel Top-100 fleet purchase pattern of a vehicle upfitting process in accordance with the present invention; and

FIG. 19 is a swim lane diagram illustrating a novel “free OEM market purchase pattern of a vehicle upfitting process in accordance with the present invention.

### DETAILED DESCRIPTION OF THE PREFERRED EMBODIMENTS

The following description of the preferred embodiments is merely exemplary in nature and is in no way intended to limit the invention, its application, or uses.

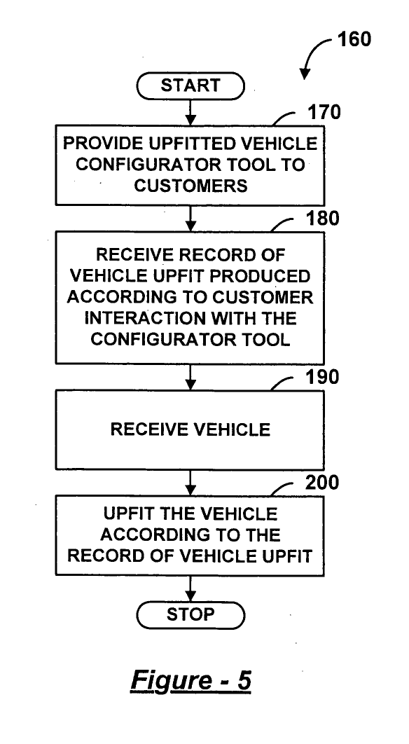

Turning to FIG. 5, a method 160 of manufacturing an upfitted vehicle includes steps 170-200. At step 170, an upfitted vehicle configurator tool is provided to customers. The configurator tool is capable of actively visually rendering an upfitted vehicle according to customer interaction with the configurator tool specifying vehicle upfit selections. The configurator tool is also capable of producing a record of a vehicle upfit according to the selections.

At step 180, a record of a vehicle upfit produced according to customer interaction with the configurator tool is received. In some embodiments, receiving the record of the vehicle upfit can include receiving a visual rendering of an upfitted vehicle. Alternatively or additionally, receiving the record of the vehicle upfit can include receiving a bill of material specifying vehicle upfitting components. Unless performed by a vehicle manufacturer, embodiments of method 160 typically include receiving a vehicle at step 190. The vehicle can be received from a vehicle manufacturer, a vehicle dealer, or customer. The vehicle received in step 190 is in an at least partially non-upfit condition compared to the record of vehicle upfit. In other words, the vehicle when received may be partially upfitted compared to the record of vehicle upfit. The vehicle is then upfitted at step 200 according to the record of the vehicle upfit.

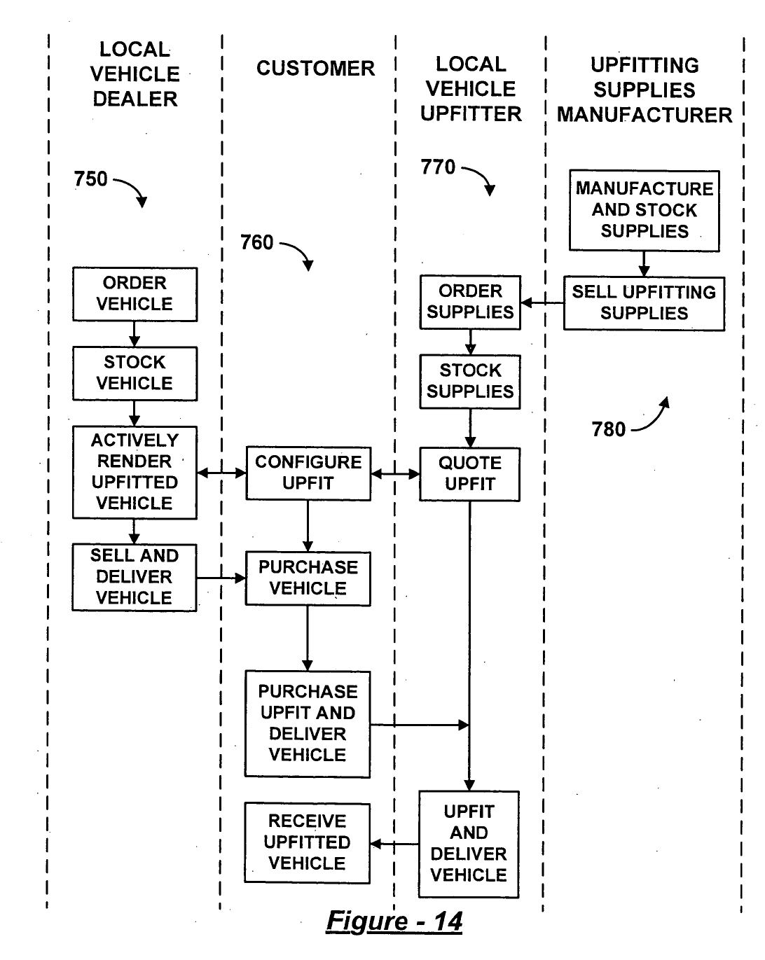

In some embodiments, method 160 can include additional steps illustrated in FIGS. 14-18, such as quoting a price for upfitting the vehicle based on retail prices of vehicle upfitting components specified by the record of vehicle upfit and/or service charges for installing the vehicle upfitting components in a vehicle. If the vehicle is partially upfitted when received, then the price quoted may include retail prices for only those upfitting components that need to be added, plus cost of services for adding those components, and cost of services for removing components previously installed in the vehicle but not conforming to the record of vehicle upfit. In some embodiments, the quote may be adjusted to offset for value of removed components that can be placed back into inventory. Where removed parts are placed back into inventory, method 160 can include an additional step (not shown) of returning the parts to a manufacturer for credit.

Various embodiments of method 160 (FIG. 5) can provide configurator tools in step 170 having additional or alternative capabilities. For example, the configurator tool can permit a user to select a predefined package of vehicle upfitting components by specifying an occupation. Also, the configurator tool can permit a user to add and remove predefined modules of plural vehicle upfitting components as well as individual components, including individual components of the predefined modules. Further, the configurator tool can permit a user to position vehicle upfitting components by drag and drop of vehicle upfitting components from a palette of components into a three-dimensional coordinate space representing a vehicle cavity.

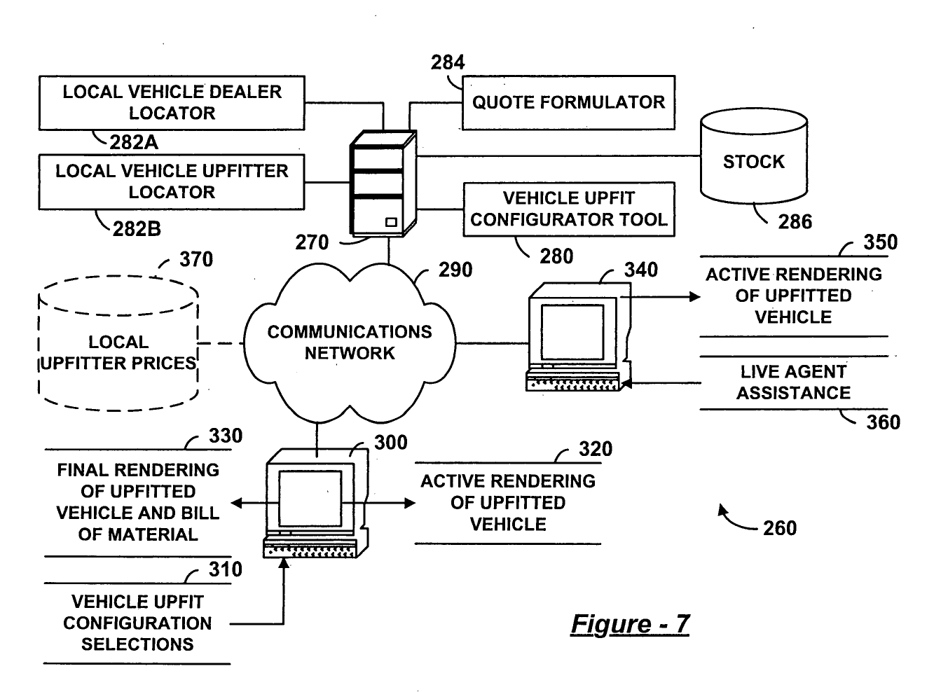

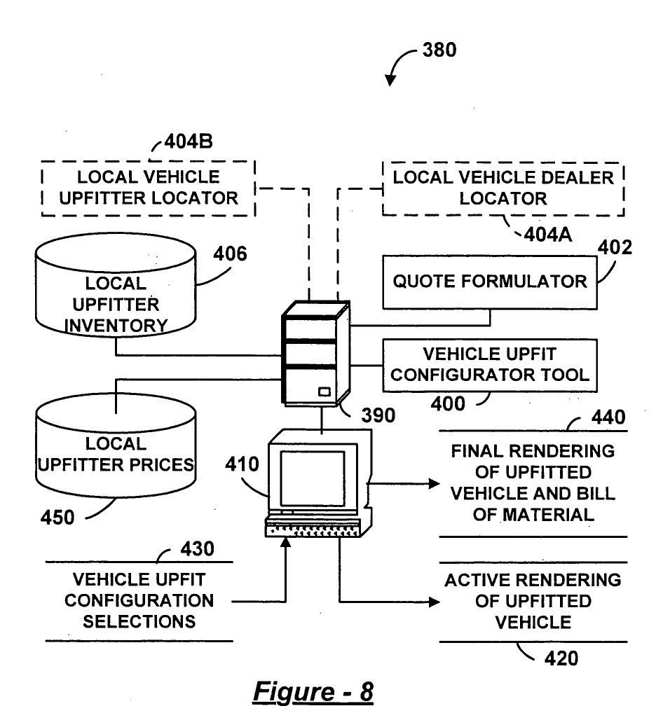

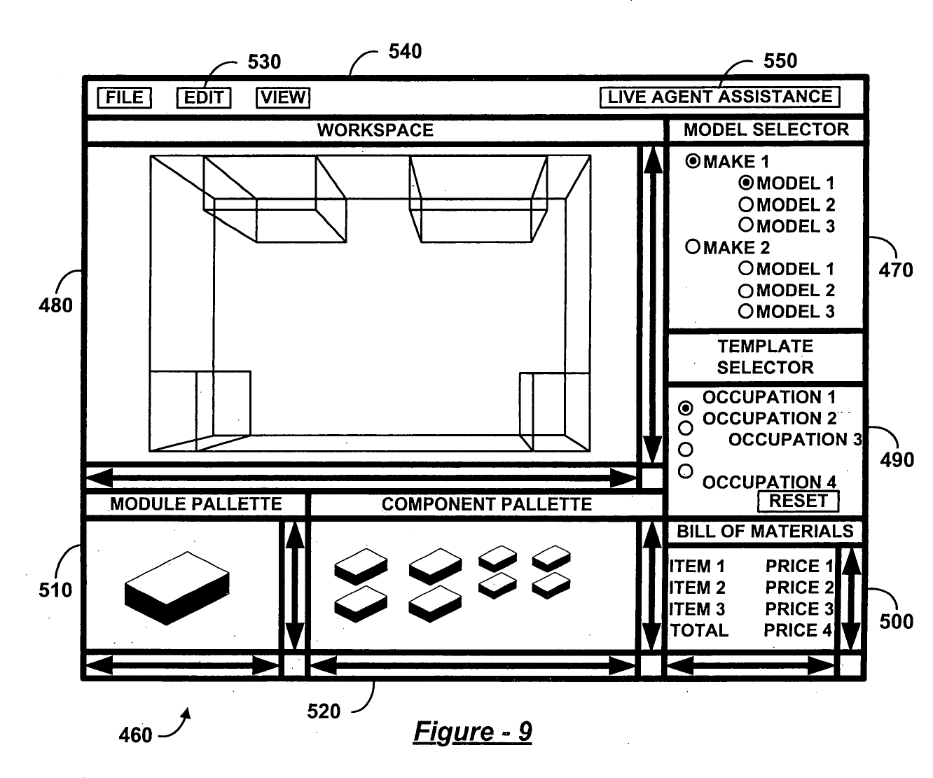

The palette of components and the three dimensional coordinate space can be actively rendered as separate regions of an active display (FIG. 9). Yet further, the configurator tool can be maintained on a website that allows customers to access the configurator tool over a communications network (FIG. 7). Further still, live agent assistance can be provided to users accessing the configurator tool over the communications network in the form of a hyperlink on the active display. Even further, the configurator tool can be provided in a desktop form (FIG. 8). For example, the configurator tool can be provided to customers at an establishment of an upfitting service provider, and personnel of the upfitting service provider can be trained to assist users of the configurator tool. Also, the configurator tool can be provided to customers at an establishment of a vehicle dealer, and personnel of the vehicle dealer can be trained to assist users of the configurator tool.

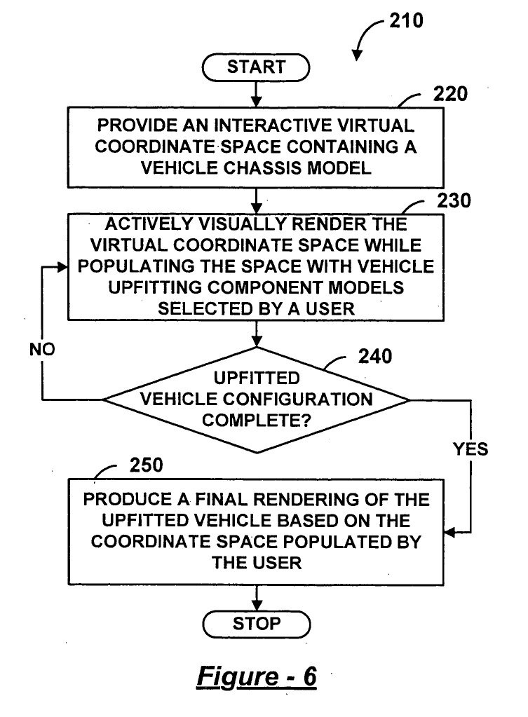

Turning now to FIG. 6, a method 210 of manufacturing a record of a vehicle upfit for use in manufacturing an upfitted vehicle includes steps 220-250. At step 220, an interactive virtual coordinate space is provided in computer memory for containing a vehicle chassis model. At step 230, contents of the virtual coordinate space are actively visually rendered while the virtual coordinate space is populated with vehicle upfitting component models selected by a user. If the configuration process is complete as at decision step 240, then a record of a vehicle upfit is generated based on user population of the coordinate space at step 250. The record of vehicle upfit can be produced in the form of a visual rendering of an upfitted vehicle. Alternatively of additionally, the record of the vehicle upfit can be produced in the form of a bill of material specifying vehicle upfitting components.

In some embodiments, method 210 can include additional steps illustrated in FIGS. 14-18, such as quoting a price for upfitting the vehicle based on retail prices of vehicle upfitting components that are specified or that will be specified by the record of vehicle upfit and/or service charges for installing the vehicle upfitting components in a vehicle. In some embodiments, some components can be excluded by the user to reflect that the vehicle is already partially upfitted. In this case, the price quoted may include retail prices for only those upfitting components that need to be added, plus cost of services for adding those components, and cost of services for removing components previously installed in the vehicle but not conforming to the record of vehicle upfit. In some embodiments, the quote may be adjusted to offset for value of removed components that can be placed back into inventory. In some embodiments, the quote can be provided by an expert assisting the user, such as a live agent in an online embodiment (FIG. 7), or vehicle upfitter or vehicle dealer personnel in a desktop embodiment (FIG. 8) implemented at a local/regional upfitter's establishment or a vehicle dealership. In other embodiments, the quote can be produced automatically using a quoting function that calculates the quote based on the components of the record of vehicle upfit and based on data pulled from one or more accessible price datastores.

Various embodiments of method 210 (FIG. 6) can allow users to interact with the virtual coordinate space in additional or alternative ways. For example, the configurator tool can permit a user to select a predefined package of vehicle upfitting components by specifying an occupation. Also, the configurator tool can permit a user to add and remove predefined modules of plural vehicle upfitting components as well as individual components, including individual components of the predefined modules. Further, the configurator tool can permit a user to position vehicle upfitting components by drag and drop of vehicle upfitting components from a palette of components into a three-dimensional coordinate space representing a vehicle cavity. The palette of components and the three dimensional coordinate space can be actively rendered as separate regions of an active display (FIG. 9).

Turning to FIG. 7, a web-based embodiment 260 of a vehicle upfit configuration system includes a server 270, such as one belonging to a vehicle upfitting component manufacturer, providing a vehicle upfit configurator tool 280 to customers over a communications network 290, such as the Internet. A customer's personal or office computer 300 connected to network 290 implements vehicle upfit configurator tool 280. Accordingly, computer 300 receives vehicle upfit configuration selections 310 from the customer, and produces an active rendering 320 of an upfitted vehicle according to the selections.

Computer 300 also produces a record of vehicle upfit 330 that is useful in accurately upfitting a vehicle. In some embodiments, the record of vehicle upfit 330 can include a final rendering of the upfitted vehicle. Alternatively or additionally, the record of vehicle upfit 330 can include a bill of material enumerating vehicle upfitting components.

A quote for vehicle upfitting supplies and/or services can be included in the record of vehicle upfit 330. Quote formulator 284 provided by server 270 can form the quote based on the selected components and a manufacturer's suggested retail prices (MSRP) of the components in the record. Quote formulator 284 can apply a discount for components that are overstocked as indicated by datastore 286. Accordingly, a quote formulated via the website can include a total cost of components based on MSRP, which can be discounted based on stock levels. Then, the local upfitter can easily order the components, which may already be discounted, and add service charges when presented with the record of vehicle upfit and the quote. Alternatively or additionally, the local upfitter can change the quote to reflect variations from MSRP.

Alternatively or in addition, server 270 can provide access to local vehicle dealer locator 282A and/or local vehicle upfitter locator 282B. Locators 282A and 282B can find vehicle dealers and vehicle upfitters for users based on location, thus directing customers to local providers. In some embodiments, locators 282A and 282B can use information from the record of vehicle upfit 330, such as vehicle type and upfit component type, respectively. In some embodiments, once a local vehicle upfitter has been selected by the user, quote formulator 284 can pull local upfitter prices from datastore 370. Local upfitter prices can pertain to service charges for installing components, and prices of components that can vary from MSRP. In some cases, the local prices in datastore 370 can be adaptively discounted based on inventory levels at the local upfitter. Thus, the quote formulated via the website may exactly reflect the local upfitter's total.

In addition, locator 282B may use information about a local upfitter's inventory when directing customers to the local upfitters. This practice can encourage local upfitters to keep a well-maintained inventory. In addition, customers can be permitted to wholly or partially purchase the upfit online, which can result in automatic shipment of needed inventory to the selected local upfitter. For example, the customer can be permitted to purchase the upfitting components online, and to purchase the upfitting services at the local upfitter's establishment. In a related embodiment, purchasers accessing the website from a location of a vehicle dealer can be permitted to partially redeem an offer for a free upfit online in this manner.

In a preferred sub-embodiment of the web-based embodiment, live agent assistance is provided over communications network 290 to users of configurator tool 280. Accordingly, configurator tool 280 is adapted to automatically connect computer 300 to a computer 340 of a live agent at the request of the customer, and is capable of allowing computer 340 and computer 300 to simultaneously access and manipulate the same virtual coordinate space. As a result, computer 340 can produce an active rendering 350 of the upfitted vehicle modeled in the virtual coordinate space for the live agent.

The customer and live agent can communicate by instant messaging and/or by telephone or videoconference. The live agent can provide assistance 360 in various ways. For example, the live agent can instruct the user in using the configurator tool, operate the configurator tool for the customer, answer questions that help the customer make decisions, and/or direct the customer to appropriate local upfitting service providers. In some embodiments, the live agent can access one or more datastores 370 of upfitting supplies costs and/or installation costs, and can formulate a quote for the user. In other embodiments, configurator tool 280 is capable of accessing such datastores and automatically formulating a quote as discussed above. Alternatively or additionally, users accessing the website from an establishment of a local upfitter or vehicle dealer can obtain assistance from trained personnel of the local upfitter or vehicle dealer. Thus, human, expert assistance is provided in a number of ways.

Turning to FIG. 8, a desk-top embodiment 380 of a vehicle upfit configuration system can be implemented at an establishment of a local/regional vehicle upfitter and/or vehicle dealer. Computer processor 390 runs the vehicle configurator tool 400 software. User interface 410 produces an active rendering 420 of the upfitted vehicle to the user, while accepting vehicle upfit configuration selections 430 from the user. User interface 410 also provides a record of vehicle upfit 440 as described above.

The desktop embodiment 380 allows for trained personnel of the vehicle upfitter or vehicle dealer to assist customers in operating the configurator tool 400 as described above. Accordingly, the trained personnel can provide a quote as appropriate. Alternatively, datastore 450 can supply pricing data that can be used by quote formulator 402 to automatically provide a quote as described above. Formulator 402 can access local upfitter inventory of datastore 406 when applying a discount based on stock levels. If provided at an establishment of a local upfitter, local vehicle dealer locator 404A can automatically locate an appropriate local vehicle dealer as described above; alternatively, personnel of the local upfitter can direct the customer to the local vehicle dealer. If provided at an establishment of a local vehicle dealer, local vehicle upfitter locator 404B can automatically locate an appropriate local vehicle upfitter as described above; alternatively, personnel of the vehicle dealer can direct the customer to the local vehicle upfitter. It is envisioned that a desktop embodiment 380 implemented at a vehicle dealership may quote an upfitted vehicle, or a vehicle plus an upfit, or a vehicle plus an upfit upgrade as appropriate.

Turning to FIG. 9, a graphic user interface 460 of the vehicle upfit configuration system has display regions 470-520. For example, display region 470 permits a user to select a make and/or model of vehicle. Upon such selection, a virtual coordinate space that is actively rendered in display region 480 is populated with a corresponding model of a vehicle chassis. If desired, the user can next select a vehicle upfit template by specifying an occupation using display region 490. In response, a template of vehicle upfitting component models compatible with selected vehicle chassis are positioned in the coordinate space in predetermined locations respective of the vehicle chassis. The template is designed to provide a set of vehicle upfitting component modules that are useful in the specified occupation, and that are positioned in convenient locations respective of the vehicle chassis. The modules are composed of multiple vehicle upfitting components. In addition, the components of the template are added to a bill of material displayed in region 500.

The user can reposition individual components or modules. Alternatively or additionally, the user can select to remove modules or individual components, including one or more components of a module, by selecting the module or component in region 480 and choosing an option to remove the selected components from an edit menu 530 of toolbar 540. Removing component models from the virtual coordinate space also removes the corresponding items from the bill of material displayed in region 500. If a quote is being formulated in the bill of material, then some embodiments can allow a user to indicate that a component is currently present in a vehicle to be upfitted or reupfitted, so that cost for removing the component can be included in the bill of material. As discussed above, this cost can be offset by a benefit obtained by placing the component back into inventory.

Alternatively or additionally, the user can select to add modules of component models from region 510 or individual component models from region 520. In some embodiments, the user can select a module in region 510 in order to cause the individual component models thereof to be displayed in region 520. Additionally or alternatively, a user can select a new template without resetting the current template in region 490 in order to cause modules of that to appear in region 510. Thus, users can mix and match modules from different templates, and mix and match component models of different modules of different templates. The user can also reset the template and/or vehicle chassis at any time.

Some embodiments allow the user to rotate the virtual coordinate space three-dimensionally in region 480. Yet further, some component models can be three-dimensional and have volume, while others are substantially two dimensional and attach to a vehicle chassis surface or a module surface. Further still, some embodiments allow the user to request live agent assistance as detailed above by selecting hyperlink 550 of toolbar 540. Finally, users can select to save and/or print the actively rendered coordinate space and/or bill of materials at any time.

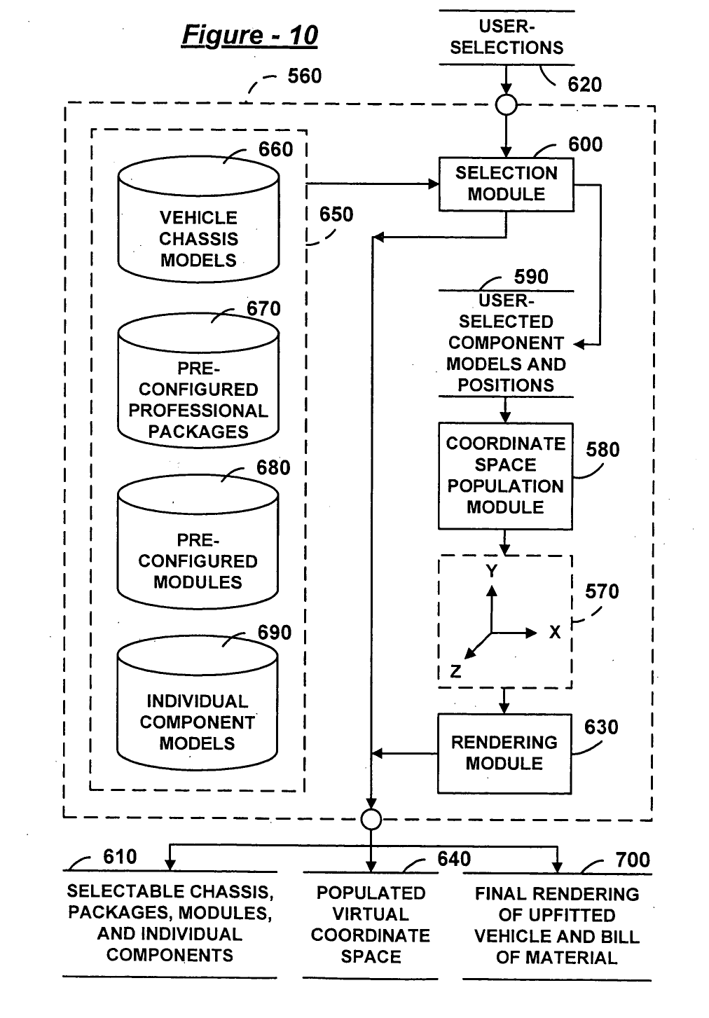

Turning now to FIG. 10, a vehicle upfit configuration system 560 has an interactive virtual coordinate space 570 residing in processor memory. A population module 580 populates the virtual coordinate space with vehicle upfitting component models 590 selected by a user. A selection module 600 communicates available selections 610, including selectable vehicle upfitting component models, to the user. Selection module 600 also receives user selections 620 positioning vehicle upfitting component models in the virtual coordinate space 570, and communicates the user selections 620 to the population module 580 as positioned component models 590.

A rendering module 630 produces an active visual rendering 640 of the virtual coordinate space populated by the user. Datastores 650 provide selectable vehicle chassis models 660, pre-configured professional packages 670 of component modules in predetermined positions respective of a vehicle chassis, pre-configured modules 680 of individual component models in predetermined positions respective of one another, and individual component models 690 having sizes and shapes and rules for attaching to surfaces of vehicle chassis, surfaces of modules, and/or to one another. A datastore of prices (not shown) may also be provided to assist in formulating a quote for upfitting materials and/or services. Modules 600 and 630 act together as a record generation module to produce a record of a vehicle upfit 700 in the form of a final rendering of an upfitted vehicle and a corresponding bill of material based on user population of the coordinate space 570 as detailed above.

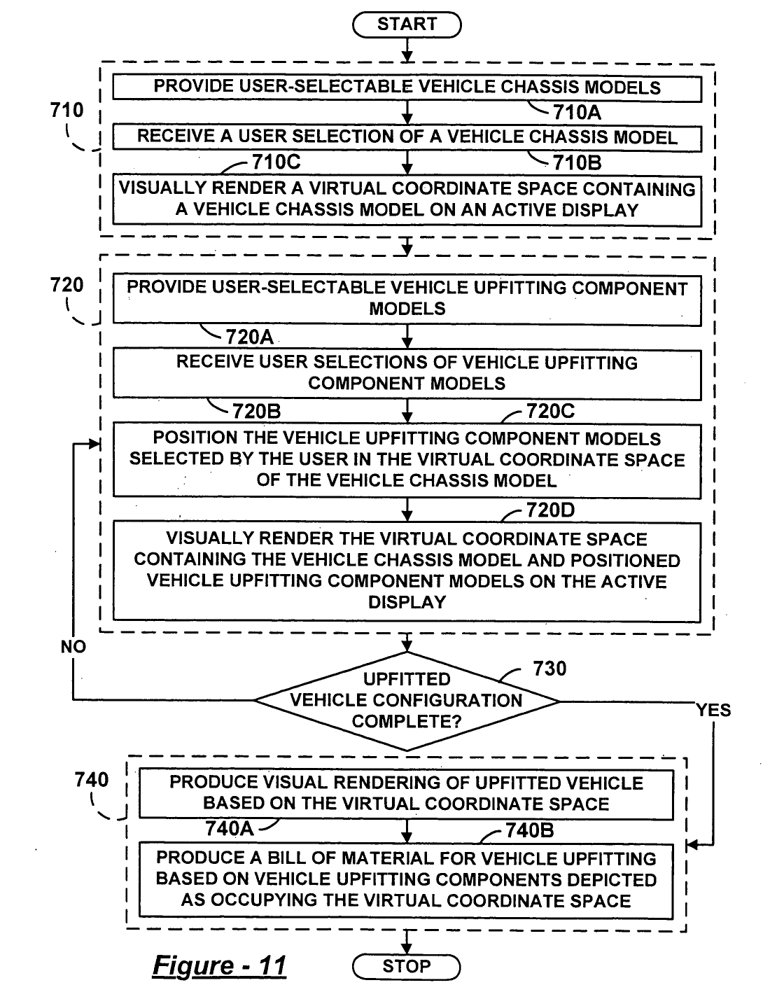

Turning now to FIG. 11, a method of operation for a vehicle upfit configuration system includes steps 710-740. At step 710, an interactive virtual coordinate space is provided in computer memory for containing a vehicle chassis model. Step 710 includes substeps 710A-710C. At sub-step 710A, user-selectable vehicle chassis models are provided to the user for selection, and a user selection of the vehicle chassis model is received at sub-step 710B. At sub-step 710C, the virtual coordinate space containing the vehicle chassis model is rendered to the user. At step 720, contents of the virtual coordinate space are actively visually rendered while the virtual coordinate space is populated with vehicle upfitting component models selected by the user. Step 720 includes sub-steps 720A-720D. At sub-step 720A, vehicle upfitting component models that are compatible with the vehicle chassis in the virtual coordinate space are made available for user selection.

User selections of vehicle upfitting component models are next received at sub-step 720B, and the models are positioned in the coordinate space at sub-step 720C. The coordinate space containing the vehicle chassis model and the vehicle upfitting component models is rendered at sub-step 720D. If the configuration process is complete at decision step 730, then a record of a vehicle upfit is generated based on user population of the coordinate space at step 740. Step 740 includes sub-steps 740A and 740B. At sub-step 740A, the record of vehicle upfit is produced in the form of a visual rendering of an upfitted vehicle. At sub-step 740B, the record of the vehicle upfit is also produced in the form of a bill of material specifying vehicle upfitting components.

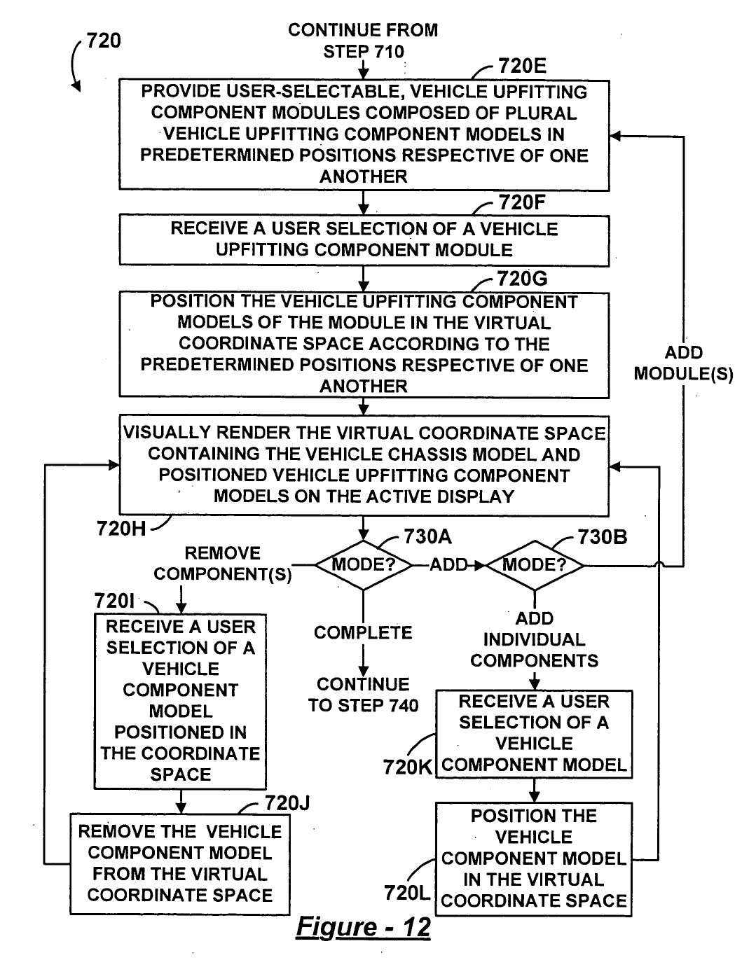

Turning to FIG. 12, some embodiments of the method of operation for a vehicle upfit configuration system according to the present invention provide pre-defined modules of vehicle upfitting component models having pre-defined positions respective of one another. Some modules are function specific in that they combine functionally identical components, such as all storage spaces. Other modules are task specific in that they combine different components directed toward a common task, such as fitted storage spaces for holding functionally interoperable machines. Other modules are hybrid modules, and combine useful components in as efficient a manner as possible. In any case, these modules can have rules specifying how the modules attach to vehicle chassis model surfaces, surfaces of other modules, and/or surfaces of individual vehicle upfitting component models. Accordingly, step 720 has alternative or additional sub-steps 720E-720L. At sub-step 720E, vehicle upfitting component modules that are eligible for placement in the vehicle chassis model are provided for user selection, and a user selection positioning a module in the coordinate space is received at sub-step 720F. At sub-step 720G, individual component models of the module are positioned in the coordinate space based on the user selection and the pre-determined positions of models in the module respective of one another. At sub-step 720H, the virtual coordinate space and the models therein are automatically actively rendered to the user.

Depending on user selection of how to proceed at decision sub-steps 730A and 730B, step 720 can continue in various ways. For example, a user selection can be received at sub-step 7201 to remove particular vehicle component models from the coordinate space. If so, the components are removed from the coordinate space at sub-step 720J, and step 720 returns to sub-step 720H. Also, a user selection positioning a vehicle upfitting component model in the coordinate space can be received at sub-step 720K. If so, the vehicle component model is positioned in the coordinate space as indicated by the user at sub-step 720L, and step 720 returns to sub-step 720H. Finally, the user can select to add new modules.

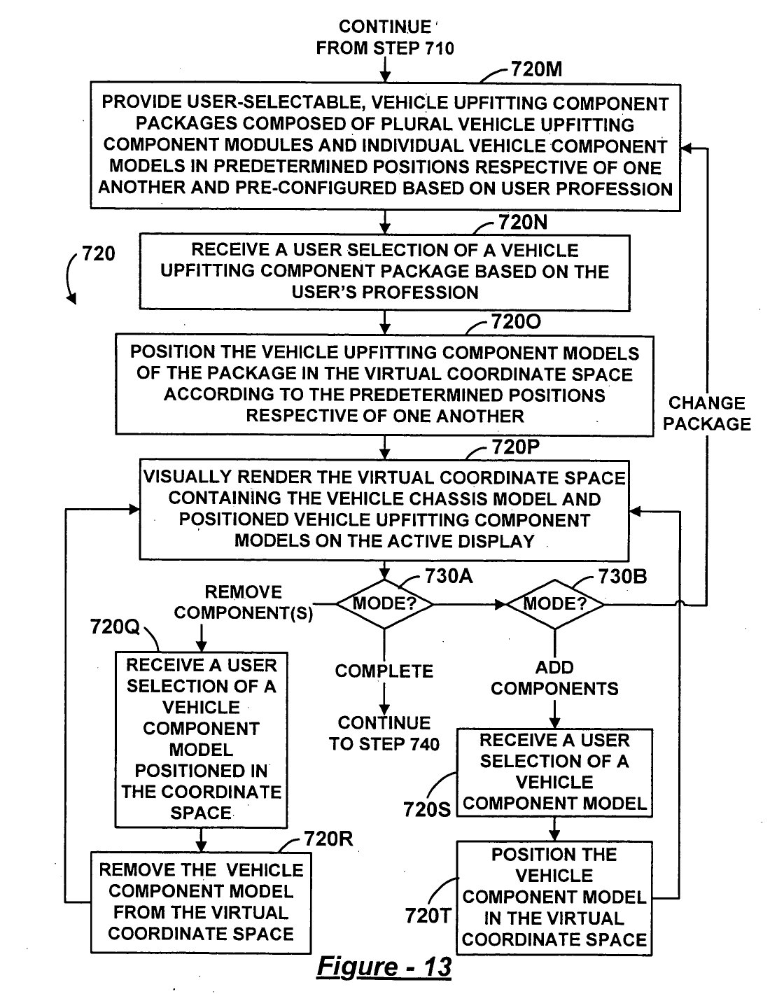

Turning to FIG. 13, some embodiments of the method of the method of operation for a vehicle upfit configuration system according to the present invention provide pre-defined templates of vehicle upfitting component modules having pre-defined positions respective of a vehicle chassis model. The templates are designed to provide an effective selection of profession specific modules in convenient positions in a particular vehicle chassis model. The individual models making up the modules are compatible with the vehicle chassis model. Accordingly, step 720 has alternative or additional sub-steps 720M-720T. At sub-step 720M, vehicle upfitting component templates that are eligible for placement in the vehicle chassis model are provided for user selection, and a user selection of the user's profession is received at sub-step 720N. At sub-step 7200, individual component models of the modules of the template are positioned in the coordinate space based on the user selection, the predetermined positions of the modules respective of the vehicle chassis, and the pre-determined positions of models in the modules respective of one another. At sub-step 720P, the virtual coordinate space and the models therein are automatically actively rendered to the user.

Depending on user selection of how to proceed at decision sub-steps 730A and 730B, step 720 can continue in various ways. For example, a user selection can be received at sub-step 720Q to remove particular vehicle component models from the coordinate space. If so, the components are removed from the coordinate space at sub-step 720R, and step 720 returns to sub-step 720P. Also, a user selection positioning a vehicle upfitting component model in the coordinate space can be received at sub-step 720S. If so, the vehicle component model is positioned in the coordinate space as indicated by the user at sub-step 720T, and step 720 returns to sub-step 720P. Finally, the user can select to select a new template.

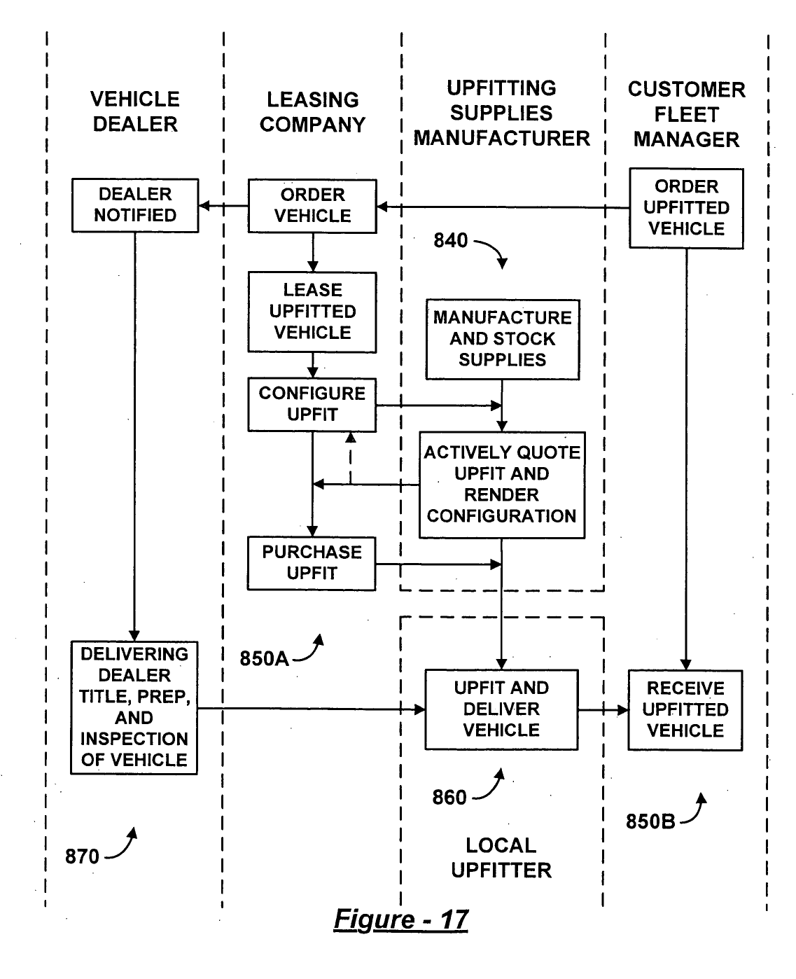

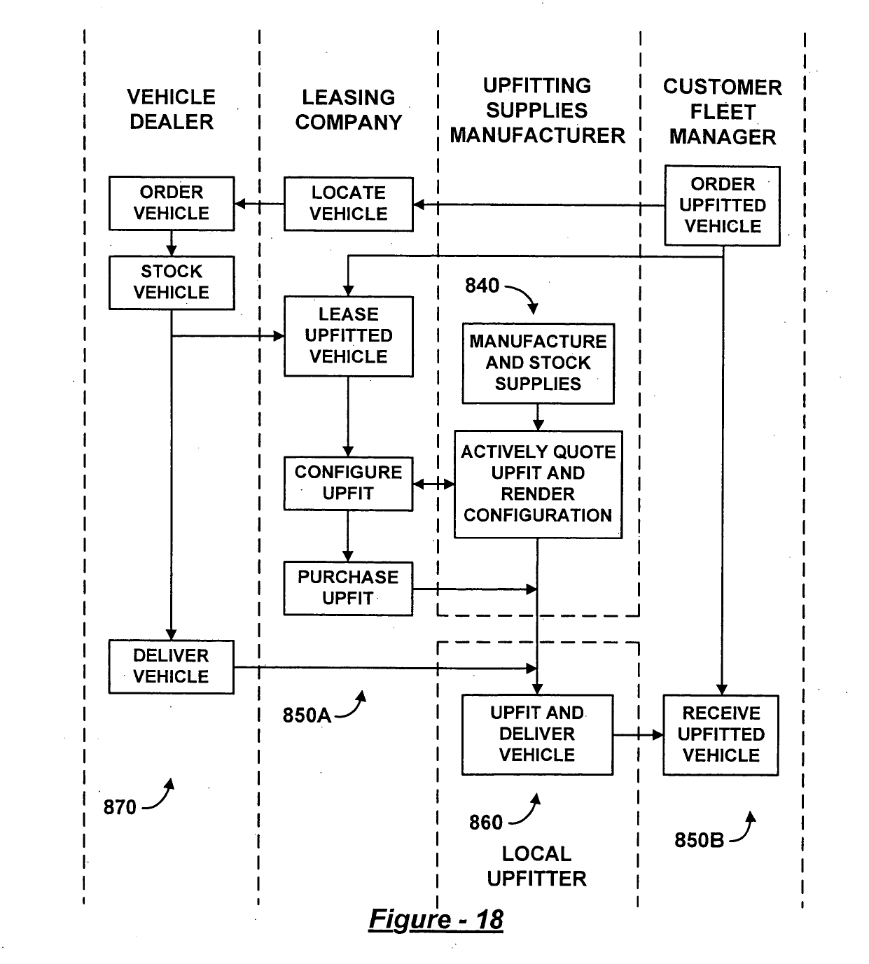

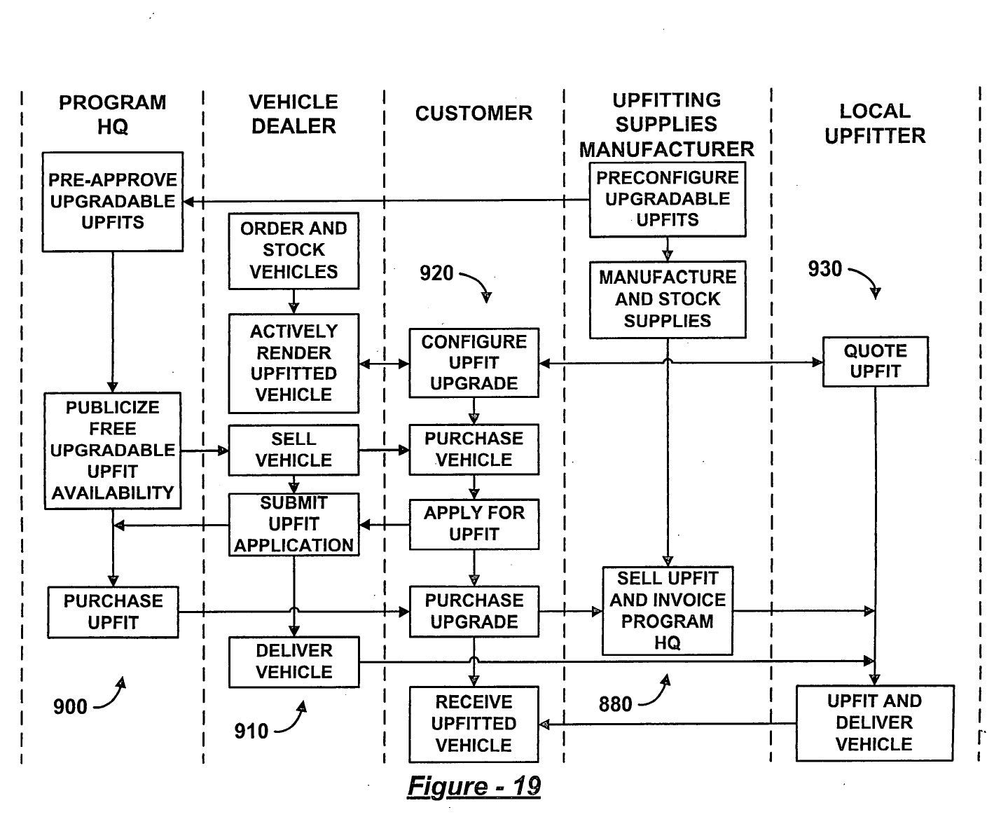

Turning now to FIGS. 14-19, various vehicle upfitting processes can benefit from provision of the vehicle upfit configurator tool in various ways. For example, new regional/local purchase patterns of FIGS. 14-16 benefit by providing the configurator tool to customers at establishments of vehicle dealers and local vehicle upfitters, and/or on websites of vehicle component supplies manufacturers. Also, new Top-100 fleet purchase patterns of FIGS. 17-18 benefit by providing the configurator tool to customers on websites of vehicle component supplies manufacturers. Further, a new “free” OEM market purchase pattern of FIG. 19 benefits by providing the configurator tool to customers at a vehicle dealership.

Turning to FIG. 14, vehicle supplying process 750 transacts with upfitted vehicle acquiring process 760 by providing the configurator tool to customers at a vehicle dealership, and by assisting customers in operating the configurator tool via trained personnel. Accordingly, the vehicle supplying process 750 receives upfit configuration selections from the upfitted vehicle acquiring process 760. The upfit configuration selections specify positions of vehicle upfitting components respective of a vehicle chassis. Upon receipt of the selections, the vehicle supplying process 750 automatically sends a record of a vehicle upfit to the upfitted vehicle acquiring process 760 in an instantaneous manner. The record of the vehicle upfit is automatically generated based on the upfit configuration selections. The vehicle supplying process 750 is also receptive of a selection of a vehicle from the upfitted vehicle acquiring process 760, and sends an at least partially upfitted vehicle to the upfitted vehicle acquiring process 760 or to vehicle upfitting process 770 based on the selection of the vehicle.

In some embodiments, the vehicle supplying process 750 sends to the vehicle upfitting process 770 and/or a vehicle upfitting component supplying process 780 the record of the vehicle upfit and a request for a quote on a price for vehicle upfitting supplies and/or services. In some embodiments, the quote may be generated automatically based on the record of vehicle upfit and received immediately by the vehicle supplying process 750. If so, vehicle supplying process 750 can send the quote to the upfitted vehicle acquiring process 760 substantially immediately and proximate in time to sending the record of vehicle upfit. In other embodiments, the vehicle supplying process 750 accesses pricing information provided by the vehicle upfitting process 770 and/or the vehicle upfitting component supplying process 780, and automatically generates a quote based on the record of vehicle upfit. If so, the vehicle supplying process 750 can send the quote to the upfitted vehicle acquiring process 760 substantially immediately and proximate in time to sending the record of vehicle upfit.

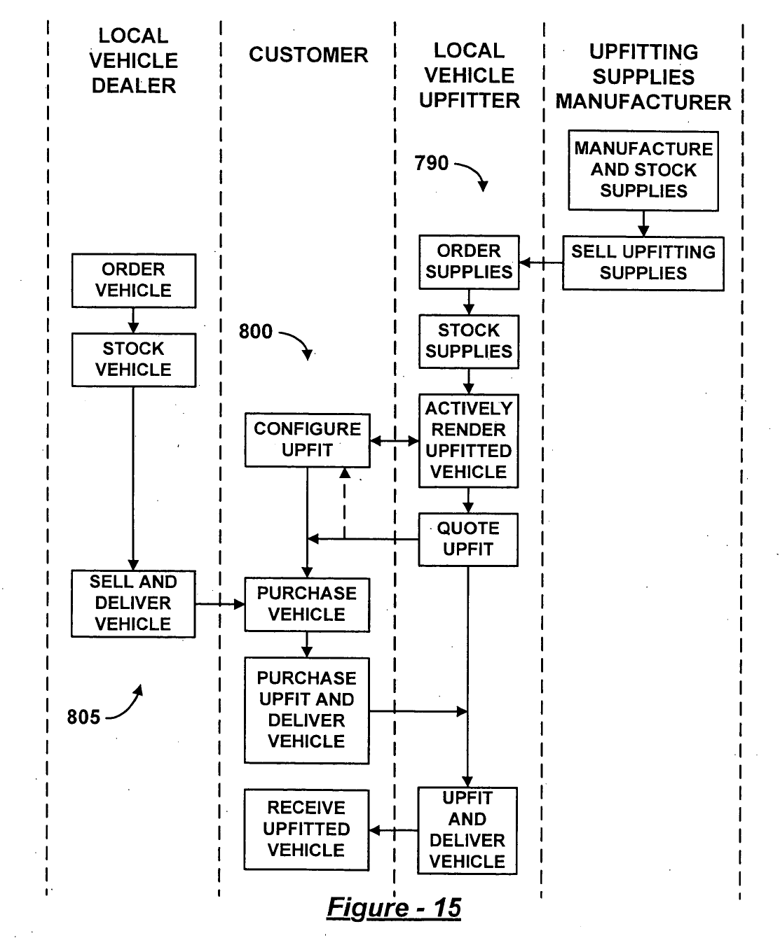

Turning to FIG. 15, vehicle upfitting process 790 transacts with upfitted vehicle acquiring process 800 by providing the configurator tool to customers at a local upfitter's establishment, and by assisting customers in operating the configurator tool via trained personnel. Accordingly, the vehicle upfitting process 790 receives upfit configuration selections from the upfitted vehicle acquiring process 800. The upfit configuration selections specify positions of vehicle upfitting components respective of a vehicle chassis. Upon receipt of the selections, the vehicle upfitting process 790 automatically sends a record of a vehicle upfit to the upfitted vehicle acquiring process 800 in a substantially instantaneous manner. The record of the vehicle upfit is automatically generated based on the upfit configuration selections. The vehicle upfitting process 790 sends a quote to the upfitted vehicle acquiring process 800, and receives in return either additional selections or a purchase of a vehicle upfit according to the record of vehicle upfit. The vehicle upfitting process 790 is also receptive of an at least partially non-upfitted vehicle from the upfitted vehicle acquiring process 800 or a vehicle supplying process 805 that is transacting with the upfitted vehicle acquiring process 800. Accordingly, the vehicle upfitting process 790 upfits the received vehicle according to the record of vehicle upfit and sends the upfitted vehicle to the upfitted vehicle acquiring process 800.

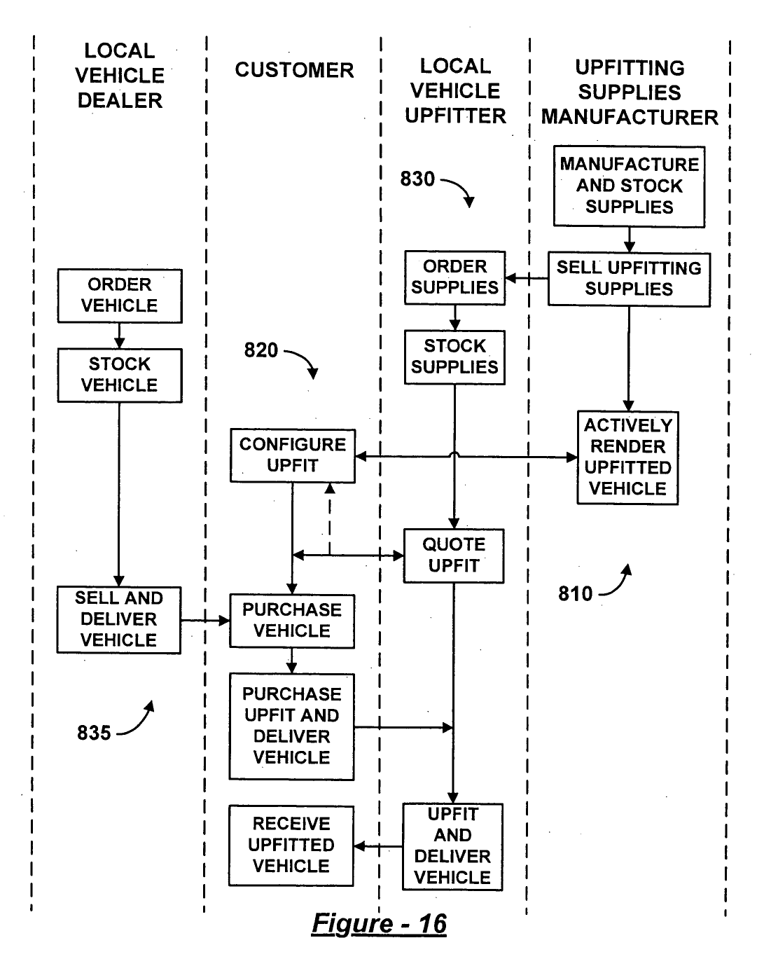

Referring to FIG. 16, vehicle upfitting supplies providing process 810 transacts with upfitted vehicle acquiring process 820 by providing the configurator tool to customers on a website, and by assisting customers in operating the configurator tool via live agent assistance. Accordingly, the vehicle upfitting supplies providing process 810 receives upfit configuration selections from the upfitted vehicle acquiring process 820. The upfit configuration selections specify positions of vehicle upfitting components respective of a vehicle chassis. Upon receipt of the selections, the vehicle upfitting supplies providing process 810 automatically sends a record of a vehicle upfit to the upfitted vehicle acquiring process 820 in a substantially instantaneous manner. The record of the vehicle upfit is automatically generated based on the upfit configuration selections. A vehicle upfitting process 830 receives the record of vehicle upfit from the upfitted vehicle acquiring process 820 and sends a quote to the upfitted vehicle acquiring process 820. Then, either the vehicle upfitting supplies providing process 810 receives additional selections or the vehicle upfitting process 830 receives a purchase of a vehicle upfit according to the record of vehicle upfit form the upfitted vehicle acquiring process 820. The vehicle upfitting process 830 also receives an at least partially non-upfitted vehicle from the upfitted vehicle acquiring process 820 or else a vehicle supplying process 835 that is transacting with the upfitted vehicle acquiring process 820. Accordingly, the vehicle upfitting process 830 upfits the received vehicle according to the record of vehicle upfit and sends the upfitted vehicle to the upfitted vehicle acquiring process 820.

Turning to FIGS. 17 and 18, upfitting supplies providing process 840 transacts with upfitted vehicle acquiring process 850A by providing the configurator tool to customers on a website, and by assisting customers in operating the configurator tool via live agent assistance. Accordingly, the vehicle upfitting supplies providing process 840 receives upfit configuration selections from the upfitted vehicle acquiring process 850A. The upfit configuration selections specify positions of vehicle upfitting components respective of a vehicle chassis. Upon receipt of the selections, the vehicle upfitting supplies providing process 840 automatically sends a record of a vehicle upfit to the upfitted vehicle acquiring process 850A in a substantially instantaneous manner. The record of the vehicle upfit is automatically generated based on the upfit configuration selections. The vehicle upfitting supplies providing process 840 automatically also sends a quote for upfitting supplies and services to the upfitted vehicle acquiring process 850A. The quote is developed based on the record of vehicle upfit. The vehicle upfitting supplies providing process receives either a purchase of the vehicle upfit, or new configuration selections from the upfitted vehicle acquisition process 850A. A vehicle upfitting process 860 receives the record of vehicle upfit and an upfit purchase order from the vehicle upfitting supplies providing process 840. The vehicle upfitting process 860 also receives an at least partially non-upfitted vehicle from a vehicle supplying process 870. Accordingly, the vehicle upfitting process upfits the vehicle according to the record of vehicle upfit, and delivers the upfitted vehicle to a second portion of the upfitted vehicle acquisition process 850B.

Turning to FIG. 19, upfitting supplies providing process 880 transacts with complementary upfit providing process 890 by sending records of pre-configured upgradeable upfits to process 890. Process 890 in turn transacts with a vehicle supplying process 900 by sending redeemable offers for complementary upfits to process 900 based on the records of pre-configured vehicle upfits. In turn, process 900 transacts with an upfitted vehicle acquiring process 910 by sending the redeemable offers, providing the upfit configurator tool, and assisting customers in operating the configurator tool via trained personnel. Accordingly, the vehicle supplying process 910 receives upfit configuration selections from the upfitted vehicle acquiring process 920. The upfit configuration selections specify positions of vehicle upfitting components respective of a vehicle chassis. Typically, the selections include a selection of a pre-configured upfit, and may also include alterations to the pre-configured upfit.

Upon receipt of upfit configuration selections, the vehicle supplying process 910 automatically sends a record of a vehicle upfit to the upfitted vehicle acquiring process 920 in a substantially instantaneous manner. The record of the vehicle upfit is automatically generated based on the upfit configuration selections. If there are alterations to the pre-configured vehicle upfit, the vehicle supplying process can send the record of vehicle upfit and the record of the pre-configured upfit to a local upfitting process 930, and receive a quote for the upfit upgrade from process 930. Vehicle supplying process 910 can then send the quote to the upfitted vehicle acquiring process 920 and receive from process 920 an application for one or more complementary upfits based on a selection of one or more of the records of pre-configured upgradeable upfits, plus a purchase of one or more vehicles. Vehicle supplying process can respond by sending the application to the complementary upfit providing process 900, and by sending a vehicle to the upfitted vehicle acquiring process 920 or a vehicle upfitting process 930.

Upon receipt of the application, the complementary upfit providing process 900 can then send a purchase order for a vehicle upfit to the vehicle upfitting component supplies providing process 880. The upfitted vehicle acquiring process 920 can also send a purchase order for one or more vehicle upfit upgrades, including one or more records of vehicle upfits that reflect alterations in the pre-configured upfits, to the upfitting component supplies providing process 880 or the upfitting process 930. The upfitting component supplies providing process 880 can also send any received purchase orders for preconfigured upfits and/or upgrades, including records of vehicle upfits, to the upfitting process 930, and send an invoice to the complementary upfit providing process 900. The upfitting process 930, upon receiving vehicles and records of upfits, can upfit the vehicles according to the records of upfits as described above, and send upfitted vehicles to the upfitted vehicle acquisition process 920.

The description of the invention is merely exemplary in nature and, thus, variations that do not depart from the gist of the invention are intended to be within the scope of the invention. For example, the web-based embodiment of FIG. 7 can also be a referral tool that directs customers to local vehicle upfitters based on the customer's location, such as a detected IP address. Accordingly, a vehicle upfitting component supplies providing process can transact with an upfitted vehicle acquiring process by sending a referral to a local vehicle upfitter and/or a vehicle dealer. Also, a computer at an establishment of a local vehicle upfitter or vehicle dealer can connect over the Internet to an online configurator tool provided at a manufacturer's website. Accordingly, a vehicle upfitting component supplies providing process can transact with an upfitted vehicle acquiring process using a local upfitting process and/or a vehicle supplying process as an intermediary. Such variations are not to be regarded as a departure from the spirit and scope of the invention.

What is claimed is:

1. A method of doing business for use with a vehicle upfit configurator tool, comprising:
making a vehicle upfit configurator tool available to customers purchasing one or more of a vehicle upfit and an upfitted vehicle;
making human assistance available to the customers, wherein the human assistance relates to use of the configurator tool; and
providing one or more of vehicles, vehicle upfitting components, and vehicle upfitting services.

2. The method of claim 1, further comprising receiving a record of a vehicle upfit produced according to customer interaction with the configurator tool.

3. The method of claim 2, wherein receiving the record of the vehicle upfit includes receiving a visual rendering of an upfitted vehicle.

4. The method of claim 2, wherein receiving the record of the vehicle upfit includes receiving a bill of material specifying vehicle upfitting components.

5. The method of claim 2, further comprising quoting a price for upfitting the vehicle based on one or more of retail prices of vehicle upfitting components specified by the record of vehicle upfit and service charges for installing the vehicle upfitting components in the vehicle.

6. The method of claim 5, further comprising applying a discount based on amounts of stock in vehicle upfitting components.

7. The method of claim 5, further comprising:
identifying vehicle upfitting components that must be removed from an upfitted vehicle as part of a process of re-upfitting the vehicle in accordance with the record of the vehicle upfit; and
applying a discount based on placement of vehicle upfitting components back into inventory.

8. The method of claim 2, further comprising upfitting a vehicle according to the record of the vehicle upfit.

9. The method of claim 1, wherein making the vehicle upfit configurator tool available includes maintaining a website that allows customers to access the configurator tool over a communications network.

10. The method of claim 9, wherein making assistance available to the customers includes providing live agent assistance to users accessing the configurator tool over the communications network via a link on the website.

11. The method of claim 1, wherein making assistance available to the customers includes training one or more of vehicle dealer personnel and vehicle upfitting service provider personnel in use of the configurator tool.

12. The method of claim 1, further comprising providing a vehicle upfitting service provider locator, wherein the locator is adapted to direct the customers to one or more vehicle upfitting service providers based on location.

13. The method of claim 12, further comprising providing a vehicle upfitting service provider locator adapted to direct the customers to one or more vehicle upfitting service providers based on a type of vehicle upfitting component specified in a record of a vehicle upfit produced according to customer interaction with the configurator tool.

14. The method of claim 1, further comprising providing a vehicle dealer locator, wherein the locator is adapted to direct the customers to one or more vehicle dealers based on location.

15. The method of claim 14, further comprising providing a vehicle dealer locator adapted to direct the customers to one or more vehicle dealers based on a type of vehicle specified in a record of a vehicle upfit produced according to customer interaction with the configurator tool.

16. The method of claim 1, further comprising providing a quote formulator, wherein the quote formulator is adapted to quote a price based on a record of a vehicle upfit produced according to customer interaction with the configurator tool, retail prices of vehicle upfitting components specified by the record of the vehicle upfit, and service charges for installing the vehicle upfitting components in a vehicle specified in the record of the vehicle upfit.

17. The method of claim 1, wherein providing the vehicle upfit configurator tool includes providing the configurator tool to customers at an establishment of a vehicle upfitting service provider.

18. The method of claim 17, further comprising training upfitting service provider personnel to assist users of the configurator tool.

19. The method of claim 17, further comprising providing a quote formulator at the establishment of the vehicle upfitting service provider, wherein the quote formulator is adapted to quote a price based on a record of a vehicle upfit produced according to customer interaction with the configurator tool, retail prices of vehicle upfitting components specified by the record of the vehicle upfit, and service charges for installing the vehicle upfitting components in a vehicle specified in the record of the vehicle upfit, wherein one or more of the retail prices and charges for services are adjustable according to preferences of the vehicle upfitting service provider.

20. The method of claim 1, wherein providing the vehicle upfit configurator tool includes providing the configurator tool to customers at an establishment of a vehicle dealer.

21. The method of claim 20, further comprising training vehicle dealer personnel to assist users of the configurator tool.

22. The method of claim 20, further comprising providing a quote formulator at the establishment of the vehicle dealer, wherein the quote formulator is adapted to quote a price based on a record of a vehicle upfit produced according to customer interaction with the configurator tool, retail prices of vehicle upfitting components specified by the record of the vehicle upfit, and service charges for installing the vehicle upfitting components in a vehicle specified in the record of the vehicle upfit, wherein one or more of the retail prices and charges for services are adjustable according to preferences of a vehicle upfitting service provider.

23. The method of claim 1, further comprising:
advertising availability of the vehicle upfit configurator tool;
directing customers to one or more of vehicle dealers and vehicle upfitting service providers; and
supplying vehicle upfitting components to a vehicle upfitting service provider.

24. The method of claim 21, further comprising negotiating a business arrangement whereby customers are directed to a vehicle dealer in exchange for a vehicle upfit being at least partially subsidized by sale of a vehicle to the customers.

25. A vehicle supplying process, comprising:
a first transaction point receptive of upfit configuration selections from an upfitted vehicle acquiring process, wherein the upfit configuration selections specify positions of vehicle upfitting components respective of a vehicle chassis, the first transaction point sending a record of a vehicle upfit to the upfitted vehicle acquiring process;
a second transaction point receptive of a selection of a vehicle from the upfitted vehicle acquiring process, and sending a vehicle to a first external process based on the selection of the vehicle.

26. The process of claim 25, wherein the first external process is the upfitted vehicle acquiring process.

27. The process of claim 26, wherein the vehicle sent at the second transaction point is upfitted according to the record of the vehicle upfit.

28. The process of claim 25, wherein the first external process is a vehicle upfitting process, and the vehicle sent is at least partially non-upfitted compared to the record of the vehicle upfit.

29. The process of claim 25, further comprising a third transaction point sending an order purchasing a vehicle upfit to a second external process based on the record of the vehicle upfit.

30. The process of claim 29, wherein the second external process is one or more of a vehicle upfitting process and a vehicle upfitting supplies providing process.

31. The process of claim 25, further comprising a third transaction point sending to a second external process the record of the vehicle upfit and a request for a quote on a price for vehicle upfitting consumptibles that conform at least in part to the record of the vehicle upfit, wherein the vehicle upfitting consumptibles are one or more of vehicle upfitting supplies and vehicle upfitting services.

32. The process of claim 31, wherein the second external process is one or more of a vehicle upfitting process and a vehicle upfitting supplies providing process.

33. The process of claim 25, further comprising a third transaction point receiving an application for a vehicle upfit from the upfitted vehicle acquisition process, wherein the application for the vehicle upfit is based on the record of the vehicle upfit.

34. The process of claim 25, further comprising a third transaction point sending an application for a vehicle upfit to a vehicle upfit providing process, wherein the application is based on the record of the vehicle upfit.

35. A vehicle upfitting process, comprising:
a first transaction point receptive of upfit configuration selections from an upfitted vehicle acquiring process, the first transaction point sending a record of a vehicle upfit to the upfitted vehicle acquiring process in a substantially instantaneous manner upon receipt of the upfit configuration selections;
a second transaction point sending an upfitted vehicle to the upfitted vehicle acquisition process, wherein the upfitted vehicle conforms to the record of the vehicle upfit.

36. The process of claim 35, further comprising a third transaction point receiving an order purchasing a vehicle upfit from an external process based on the record of the vehicle upfit.

37. The process of claim 36, wherein the external process is one or more of: (a) the upfitted vehicle acquisition process; (b) a vehicle upfitting supplies providing process; (c) a vehicle supplying process transacting with the upfitted vehicle acquisition process; and (d) a complementary upfit providing process transacting with one or more of: (1) the upfitted vehicle acquisition process; (2) a vehicle supplying process transacting with the upfitted vehicle acquisition process; and (3) a vehicle upfitting supplies providing process transacting with said vehicle upfitting process.

38. The process of claim 35, further comprising a third transaction point sending a quote for vehicle upfit materials and services to an external process based on the record of the vehicle upfit.

39. The process of claim 38, wherein the external process is one or more of: (a) the upfitted vehicle acquisition process; (b) a vehicle upfitting supplies providing process; (c) a vehicle supplying process transacting with the upfitted vehicle acquisition process; and (d) a complementary upfit providing process transacting with one or more of: (1) the upfitted vehicle acquisition process; (2) a vehicle supplying process transacting with the upfitted vehicle acquisition process; and (3) a vehicle upfitting supplies providing process transacting with said vehicle upfitting process.

40. The process of claim 35, further comprising a third transaction point receiving the vehicle in a non-upfit condition from an external process, wherein the vehicle is at least partially non-upfitted compared to the record of vehicle upfit upon receipt thereof.

41. The process of claim 40, wherein the external process is one or more of the upfitted vehicle acquisition process and a vehicle supplying process transacting with the upfitted vehicle acquisition process.

42. A vehicle upfitting supplies providing process, comprising:
a first transaction point receptive of upfit configuration selections from an external process, the first transaction point automatically sending a record of a vehicle upfit to the external process in a substantially instantaneous manner upon receipt of the upfit configuration selections;
a second transaction point sending vehicle upfitting supplies to a vehicle upfitting process, wherein the upfitting supplies conform to types of vehicle upfitting components specified in the record of the vehicle upfit.

43. The process of claim 42, further comprising sending a quote for vehicle upfit materials and services to an external process based on the record of the vehicle upfit.

44. The process of claim 42, further comprising a third transaction point receiving an order purchasing a vehicle upfit from the external process based on the record of the vehicle upfit.

45. The process of claim 42, wherein the external process is one or more of: (a) an upfitted vehicle acquisition process; (b) a vehicle upfitting process; (c) a vehicle supplying process transacting with an upfitted vehicle acquisition process; and (d) a complementary upfit providing process transacting with one or more of: (1) the upfitted vehicle acquisition process; and (2) a vehicle supplying process transacting with the upfitted vehicle acquisition process.
